(19) United States
(12) Patent Application Publication
(10) Pub. No.: US 2011/0029576 A1
(43) Pub. Date: Feb. 3, 2011

(54) Collection of Media Files

(76) Inventors: Jason Goldman, Ft. Collins, CO (US); William G. McCollom, Fort Collins, CO (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/512,557

(22) Filed: Jul. 30, 2009

(51) Int. Cl. G06F 17/30; G06F 7/00

(52) U.S. Cl. 707/803; 707/E17.009; 707/E17.014

(57) ABSTRACT

A method for generating a collection of media files including scanning metadata of media files with a processor to associate the media files with one or more media servers, utilizing the processor to identify one or more of the media servers to be associated with the collection of media files, and generating on a storage medium the collection of media files to include the media files associated with one or more of the media servers which are identified to be associated with the collection of media files.

### BACKGROUND

When a device requests to access media on another machine, the machine will access and scan a storage device on the machine for all of the media stored on the storage device. The machine will then create a list of all of the media found on the storage device and present a list of all of the media files for the requesting device to view.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the embodiments.

FIG. 1 illustrates a machine with a media manager coupled to a storage device which stores media files according to an embodiment of the invention.

FIG. 2 illustrates a block diagram of a media manager scanning metadata of media files to generate a collection of media files when a device requests to view the collection of media files according to an embodiment of the invention.

FIG. 3 illustrates a media manager accessing a database of media files on a machine to create collections of media files for devices coupled to the machine according to an embodiment of the invention.

FIG. 4 illustrates a machine with an embedded media manager and a media manager stored on a removable medium being accessed by the machine according to an embodiment of the invention.

FIG. 5 is a flow chart illustrating a method for generating a collection of media files according to an embodiment of the invention.

FIG. 6 is a flow chart illustrating a method for generating a collection of media files according to another embodiment of the invention.

### DETAILED DESCRIPTION

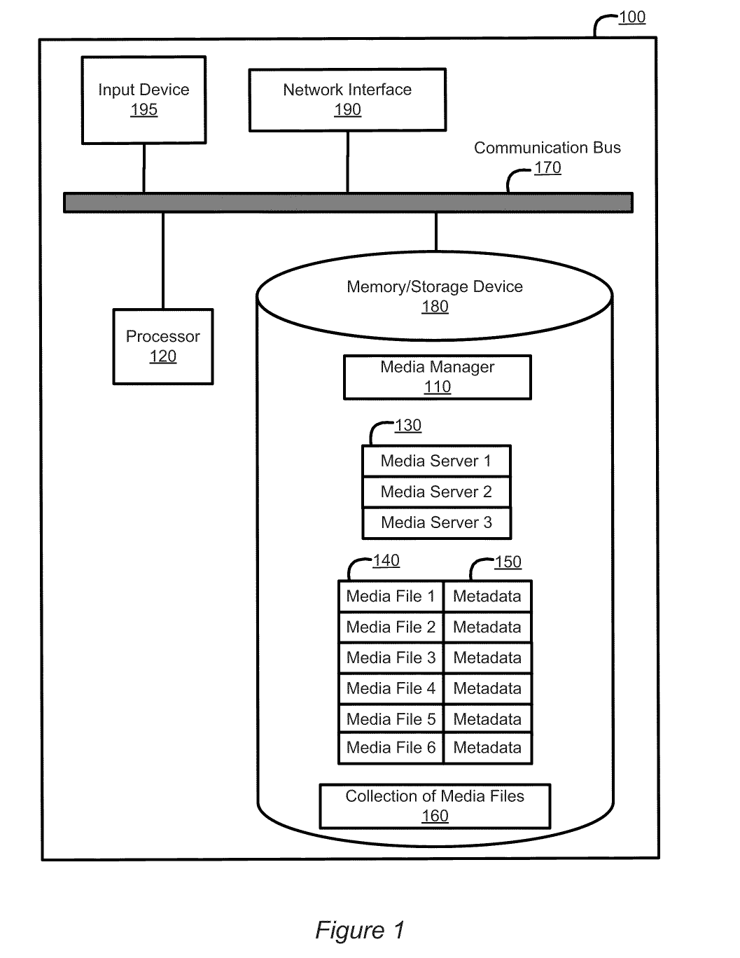

FIG. 1 illustrates a machine 100 with a media manager 110 coupled to a memory/storage device 180 which stores media files 140 according to an embodiment of the invention. The machine 100 is any device and/or apparatus which can manage media files 140 on media servers 130 and create one or more collections of media files 160 in conjunction with the media manager 110. As illustrated in FIG. 1, the machine 100 includes a processor 120, one or more input devices 195, a memory/storage device 180, a network interface 160, and a communication bus 170 for the machine 100 and/or one or more components of the machine 100 to communicate with one another.

Further, as illustrated in FIG. 1, the memory/storage device 180 stores the media manager 110, one or more media files 140, metadata for the media files 150, media servers 130, and one or more collections of media files 160. In other embodiments, the machine 100 includes additional components and/or is coupled to additional components in addition to and/or in lieu of those noted above and illustrated in FIG. 1.

As noted above, the machine 100 includes a processor 120. The processor 120 sends data and/or instructions to the components of the machine 100, such as one or more input devices 195, the memory/storage device 180 and the media manager 110. Additionally, the processor 120 receives data and/or instruction from components of the machine 100, such as the media manager 110.

The media manager 110 is an application coupled to the machine 100 and executable by the processor 120. The media manager 110 is configured by the processor 120 to access the memory/storage device 180 coupled to the machine 100 and scan the memory/storage device 180 for media files 140. Additionally, the media manager 110 scans the metadata 150 of each media file 140 to identify a user and/or media server 130 association of the corresponding media file. The media manager 110 will then create or update one or more media servers 130 to include the media files 140 which are associated with them.

Further, the media manager 110 will scan for a device requesting to view a collection of media files 160. Additionally, the media manager 110 will determine whether the device has requested to associate one or more of the media servers 130 on the machine 100 with the collection of media files 160. Once the media manager 110 has received the request, the media manager 110 will proceed to generate the collection of media files 160 to include media files 140 associated with media servers 130 which have been identified to be associated with the collection of media files 160. The media manager 110 will then allow the device to view the collection of media files 160.

In one embodiment, the media manager 110 is firmware that is embedded onto the machine 100. In other embodiments, media manager 110 is a software application stored on the machine 100 within ROM or on the memory/storage device 180 accessible by the machine 100 or the media manager 110 is stored on a computer readable medium readable and accessible by the machine 100 from a different location. Additionally, in one embodiment, the memory/storage device 180 is included in the machine 100. In other embodiments, the storage device 180 is not included in the machine 100, but is remotely accessible to the machine 100 utilizing a network interface 160 included in the machine 100. The network interface 160 may be a wired or wireless network interface card.

In a further embodiment, the media manager 110 is stored and/or accessed through a server coupled through a local area network or a wide area network. The media manager 110 communicates with devices and/or components coupled to the machine 100 physically or wirelessly through a communication bus 170 included in or attached to the machine 100. In one embodiment the communication bus 170 is a memory bus. In other embodiments, the communication bus 170 is a data bus.

As noted above, the media manager 110 will associate the media files 140 with one or more media servers 130 on the machine 100. The media manager 110 will initially scan the memory/storage device 180 for the media files 180. In other embodiments, the media manager 110 can scan the memory/storage device 180 periodically for the media files 130 and any additional media files. The media files 140 are any files which include pictures, graphics, videos, and/or audio. As noted above and as illustrated in FIG. 1, the media files 140 are stored on the memory/storage device 180. In other embodiments, the media files 140 or additional media files can be stored on additional storage devices accessible to the machine 100. The media files 140 can be accessed and executed by the machine 100 and/or one or more devices coupled to the machine 100.

One or more media servers 130 are virtual servers on the machine 100 which list media files 140 that have been associated with the corresponding media server 130. As illustrated in FIG. 1, the media servers 130 are also stored on the memory/storage device 180. In one embodiment, one or more of the media servers 130 can be associated with media file types of a specific genre. In other embodiments, the media servers 130 are each associated with users that have been registered with the machine 100. One or more users can be registered with the machine 100 utilizing one or more input devices 195 coupled to the machine 100. In one embodiment, one or more input devices 195 include a keyboard, a mouse, a touch screen, a camera, a microphone, and/or any additional device that can receive input from the user.

In associating the media files 140 with the media servers 130, the processor 120 will configure the media manager 110 to scan metadata 150 of each of the media files 140 to identify an association of the corresponding media file. As noted above, all of the media files 140 include corresponding metadata 150. In one embodiment, the media manager scans the metadata 150 of all of the media files 140 one by one. In other embodiments, the media manager 110 scans the metadata 160 of the media files 140 concurrently.

The metadata 150 list one or more users and/or one or more media servers 130 that the corresponding media file is associated with. In one embodiment, the metadata 150 additionally list a genre of the corresponding media file. In other embodiments, the metadata 150 can list and include additional details of the media files 140 in addition to and/or in lieu of those noted above. The metadata 150 can be included as part of the media files 140 or the metadata 150 can be stored as separate files which can be associated with the corresponding media files 140.

Once the media manager 110 has scanned the metadata 150 of all of the media files 140 and identified all of the users and all of the media servers 130 associated with the corresponding media files, the media manager 110 will proceed to determine whether all of the identified users are registered with the machine 100 and whether all of the identified media servers 130 are included in the machine 100. In other embodiments, the media manager 110 can periodically scan the metadata 150 of the media files 140 for any changes in user and/or media server associations and proceed to update any of the media servers in response to the update in associations.

If the identified media servers 130 are included in the machine 100, the media manager will proceed to populate the identified media servers 130 to include the media files 140 associated with them. In one embodiment, if one or more of the identified media servers 130 are not included in the machine 100, the media manager 110 can create the media servers and then proceed to populate them with the media files 140 that have been identified to be associated with them.

Additionally, in one embodiment, if a user is not registered with the machine, the media manager 110 will proceed to register the user with the machine 100 and create a corresponding media server for the user. The media manager 110 will then continue to populate the corresponding media server to include the media files 140 which have been identified to be associated with the user.

In another embodiment, if a user is already registered with the machine 100, the media manager will then determine whether the user has a corresponding media server already associated with the user. If the user already has a corresponding media server associated with the user, the media manager 110 will proceed to populate the corresponding media server to include the media files 140 which have been identified to be associated with the user. If the user does not have a corresponding media server already associated with the user, the media manager 110 will proceed to create a corresponding media server for the user and proceed to populate the corresponding media server to include media files 140 which have been identified to be associated with the user.

As illustrated in FIG. 1, in one embodiment, all of the media servers 130 are stored and listed in the memory/storage device 180. In other embodiments, the machine 100 includes a database of media files. The database of media files is a database which lists all of the media servers 130 included in the machine 100. The database can be stored on the memory/storage device 180 or it can be stored on an additional location accessible to the machine 100. The media servers 130 listed in the database of media files each list all of the media files 140 which have been identified to be associated with them. In other embodiments, the database of media files additionally list a user that is associated with the corresponding media server.

As noted above, the media manager 110 will scan for a device requesting to view a collection of media files 160. The collection of media files 160 is a file which lists media files 140 of media servers 130 which have been identified to be associated with the collection of media files 160. The processor 120 configures the media manager 110 to generate the collection of media files 160 and stores the collection of media files on the memory/storage device 180 when a device has requested to view the collection of media files 160. In another embodiment, the collection of media files 160 is stored at an additional location. In other embodiments, the media manager 110 can generate additional collections of media files when one or more devices access the machine 100 and request to view an additional collection of media files 160.

As noted above, a device can couple to the machine 100 and request to view a collection of media files 160. In one embodiment, after coupling to the machine 100, the device can query the media manager 110 for a list of the media servers 130 included in the machine 100. The media manager 110 can scan the network interface 190 and/or the communication bus 170 for the device accessing the machine 100 and querying for the list of media servers 130 included in the machine 100. In other embodiments, the device can directly query the media servers 130.

In another embodiment, the processor 120 will configure the media manager 110 to instruct the machine 100 to become discoverable to devices. The media manager 110 can instruct the machine 100 to utilize the network interface 190 to broadcast one or more media server signals. In other embodiments, the media manager 110 can configure the media servers 130 to utilize the network interface 190 to become discoverable. The media server signals are signals that can be sent through wirelessly or through a wired connection. The media server signals will include information specifying all of the media servers 130 included in the machine 100. The media server signals can also specify whether a user is associated with one of the corresponding media servers 130. In other embodiments, the media server signals list all of the media files associated with a corresponding media server.

Once the device has accessed the machine 100 and requested to view the collection of media files 160, the media manager 110 will determine whether the device has requested to associate one or more of the media servers 130 with the collection of media files 160. The device can submit a request to the media manager 110 to associate one or more of the media servers 130 with the collection of media files 160.

In one embodiment, if no request is received, the media manager 110 associates all of the media servers 130 included in the machine with the collection of media files 130. As a result, the media manager 110 will generate the collection of media files 160 to include the media files 140 associated with all of the media servers 130. In other embodiments, if the device requests that one or more of the media servers 130 be associated with the collection of media files 160, the media manager 110 will proceed to generate the collection of media files 160 to include media files 140 that are associated with the requested media servers.

Once the collection of media files 160 has been generated to list all of the media files 140 associated with the requested media servers, the media manager 110 will then allow the device to view the collection of media files 160. In one embodiment, the media manager 110 will establish a connection with the device and allow the device to view the collection of media files 160 remotely. In another embodiment, the media manager 110 will send the collection of media files 160 to the device for viewing. In other embodiments, the media manager 110 can generate additional collections of media files for the device or additional devices to view following the approach disclosed above.

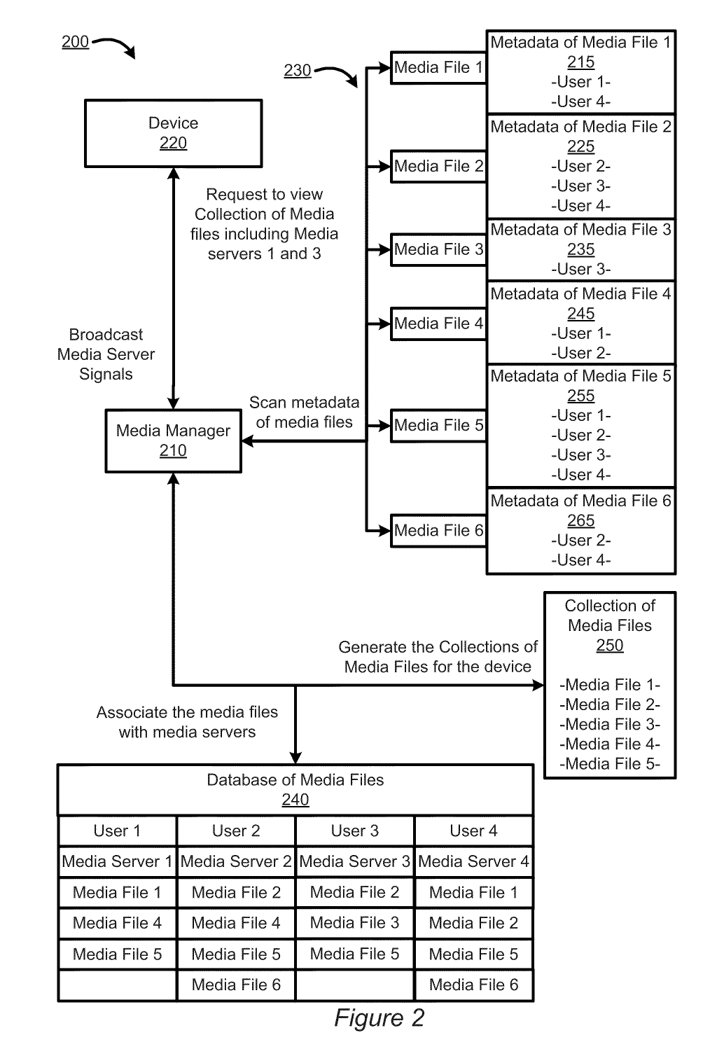

FIG. 2 illustrates a block diagram of a media manager 210 scanning metadata of media files 230 to generate a collection of media files 250 when a device 220 requests to view the collection of media files 250 according to an embodiment of the invention. As illustrated in FIG. 2, in one embodiment, a machine 200 includes media file 1, media file 2, media file 3, media file 4, media file 5, and media file 6. Additionally, as noted above, and illustrated in FIG. 2, the media files 230 each have metadata that correspond to the media files 230. Further, as noted above, the metadata of each of the media files 230 list one or more users and/or media servers that the corresponding media file is associated to.

As illustrated in FIG. 2, in one embodiment, the media manager 210 lists all of the media servers included in the machine 200 in a database of media files 240. As noted above and illustrated in FIG. 2, in one embodiment, each of the media servers are associated with a user registered on the machine 200. Additionally, as noted above, the media manager 210 scans the metadata of each of the media files 230 to identify a user and/or media server association of each of the media files 230.

As shown in FIG. 2, the media manager 210 scans the metadata of media file 1 215 and determines that the metadata of media file 1 215 specifies that media file 1 is associated with user 1 and user 4. Additionally, as illustrated in FIG. 2, the media manager 210 accesses the database of media files 240 and finds that user 1 is associated with media server 1, user 2 is associated with media server 2, user 3 is associated with media server 3, and user 4 is associated with media server 4.

As a result, the media manager 210 proceeds to update the database of media files 240 to show that media file 1 is associated with user 1 and thus media server 1. Additionally, the media manager 210 proceeds to associate media file 1 with user 4 and media server 4 in the database of media files 240. Once the media manager 210 as associated media file 1 with the media severs 1 and 4, the media manager 210 will proceed to scan the metadata of media file 2 225. As illustrated in FIG. 2, the metadata of media file 2 225 lists that media file 2 is associated with user 2, user 3, and user 4. As shown in FIG. 2, the media manager 210 will proceed to access the database of media files 240 and update the database of media files 240 to show that media file 2 is associated with user 2 and media server 2, user 3 and media server 3, and user 4 and media server 4.

Following this approach, the media manager 210 proceeds to scan the metadata of media file 3 235, the metadata of media file 4 245, the metadata of media file 5 255, and the metadata of media file 6 265. Once the media manager 210 has scanned the metadata of all of the media files, the media manager 210 proceeds to update the database of media files 240 to show that media server 1 is associated with media files 1, 4, and 5. Additionally, media server 2 is associated with media files 2, 4, 5, and 6. Further, media server 3 is associated with media files 2, 3, and 5. In addition, media server 4 is associated with media files 1, 2, 5, and 6.

As illustrated in FIG. 2, in one embodiment, the media manager 210 can scan the metadata of the media files 230 and associate the media files 230 with corresponding media servers sequentially. In other embodiments, the media manager 210 can scan the metadata of all of the media files 230 and associate the media files 230 with corresponding media servers concurrently.

Further, as illustrated in FIG. 2 and noted above, a device 220 can access a machine 200 and request to view a collection of media files 250. As noted above, the device 220 can access the machine 200 and query a media manager 210 on the machine 200 for a list of media servers available on the machine 200 or as illustrated in FIG. 2, the media manager 210 can instruct a network interface on the machine 200 to broadcast one or more media server signals. One or more media server signals can specify that the machine 200 includes media server 1, media server 2, media server 3, and media server 4.

After requesting to view the collection of media files 250, as illustrated in FIG. 2, the device 220 additionally requests to include media servers 1 and 3 in the collection of media files 250. As a result, the media manager 210 accesses the database of media files 240 to determine which media files are associated with media servers 1 and 3. As illustrated in FIG. 2 and noted above, media server 1 is associated with media files 1, 4, and 5. Additionally, media server 3 is associated with media files 2, 3, and 5.

Once the media manager 210 has identified all of the media files associated with media server 1 and 3, as illustrated in FIG. 2, the media manager 210 proceeds to generate the collection of media files for the device to view. Additionally, as illustrated in FIG. 2, because media files 1, 2, 3, 4, and 5 are associated with media server 1 and 3, the collection of media files 250 lists media files 1, 2, 3, 4, and 5. After generating the collection of media files 250, the media manager provides the collection of media files 250 for the device 220 to view.

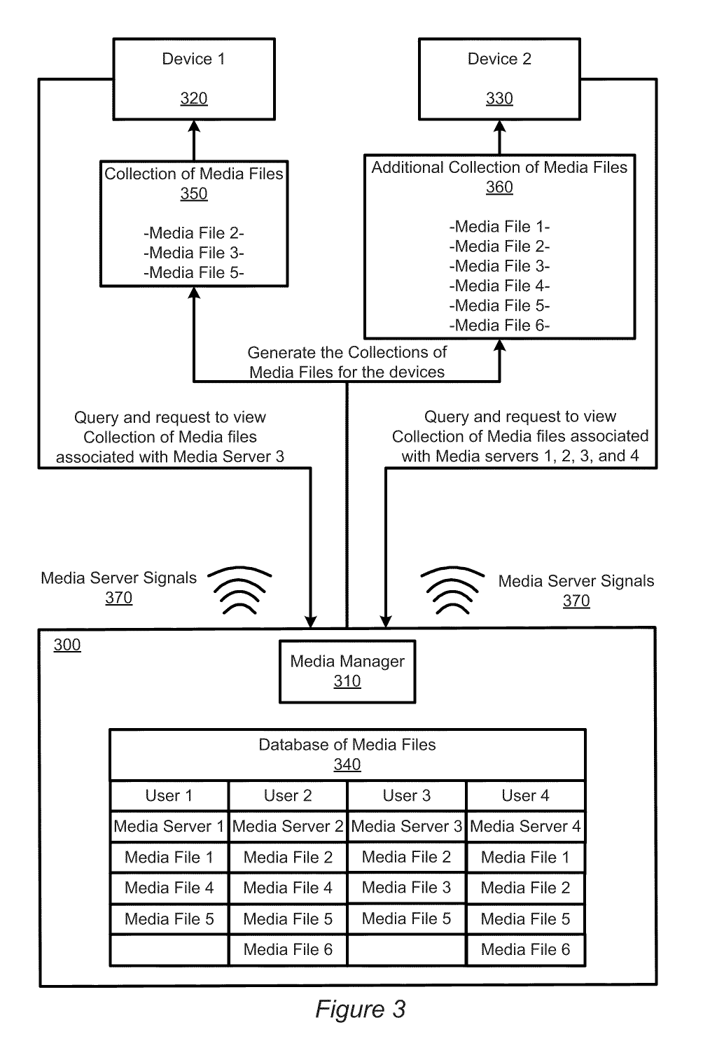

FIG. 3 illustrates a media manager 310 accessing a database of media files 340 on a machine 300 to create collections of media files 350, 360 for devices 320, 330 coupled to the machine 300 according to an embodiment of the invention. As noted above, in one embodiment, the machine 300 includes a database of media files 340. Additionally, as noted above, the database of media files 340 list all of the media servers which are included in the machine 300. Additionally, as illustrated in FIG. 3 and noted above, in one embodiment, all of the media servers listed in the database of media files 340 correspond to a user recognized by the machine 300.

As shown in FIG. 3, in one embodiment, device 1 320 and device 2 330 access the machine 300 and query the machine 300 for media servers included on the machine 300. In one embodiment, as illustrated in FIG. 3, once the media manager 310 has received the query from device 1 320 and device 2 330, the media manager 330 will proceed to send a list of media servers available on the machine through one or more media server signals 370. Once device 1 320 and device 2 330 have received the list of media servers, the devices 320, 330 can request to view one or more collection of media files 350, 360. Additionally, device 1 320 and device 2 330 can specify which of the media servers are to be associated with the collections of media files 350, 360.

As illustrated in FIG. 3, the database of media files 340 list that there are 4 media servers, media server 1, media server 2, media server 3, and media server 4. Further, as illustrated in FIG. 3, in the present embodiment, device 1 320 requests to view a collection of media files 350 and specifies that media server 3 be associated with the collection of media files 350. Additionally, as illustrated in FIG. 3, device 2 330 requests to view an additional collection of media files 360 and specifies that media servers 1, 2, 3, and 4 be associated with the additional collection of media files 360.

As noted above, once the media manager 310 has detected the requests made by device 1 320 and device 2 330, the media manager 310 will proceed to generate the collection of media files 350 for device 1 320 to view and generate the additional collection of media files 360 for device 2 330 to view. As illustrated in FIG. 3, the database of media files 340 shows that media server 3 has media file 2, media file 3, and media file 5 associated with it.

As a result, as illustrated in FIG. 3, the media manager 310 will generate the collection of media files 350 with media file 2, media file 3, and media file 5. The media manager 310 will then share the collection of media files 350 with device 1 320 to view since media files 2, 3, and 5 are associated with media server 3 and device 1 320 has requested that media server 3 be associated with the collection of media files 350.

Further, as shown in FIG. 3, since device 2 330 has requested to have all of the media servers associated with the additional collection of media files 360, all of the media files on the machine 300, media files 1, 2, 3, 4, 5, and 6 are included in the additional collection of media files 360 generated by the media manager 310 for device 2 330 to view.

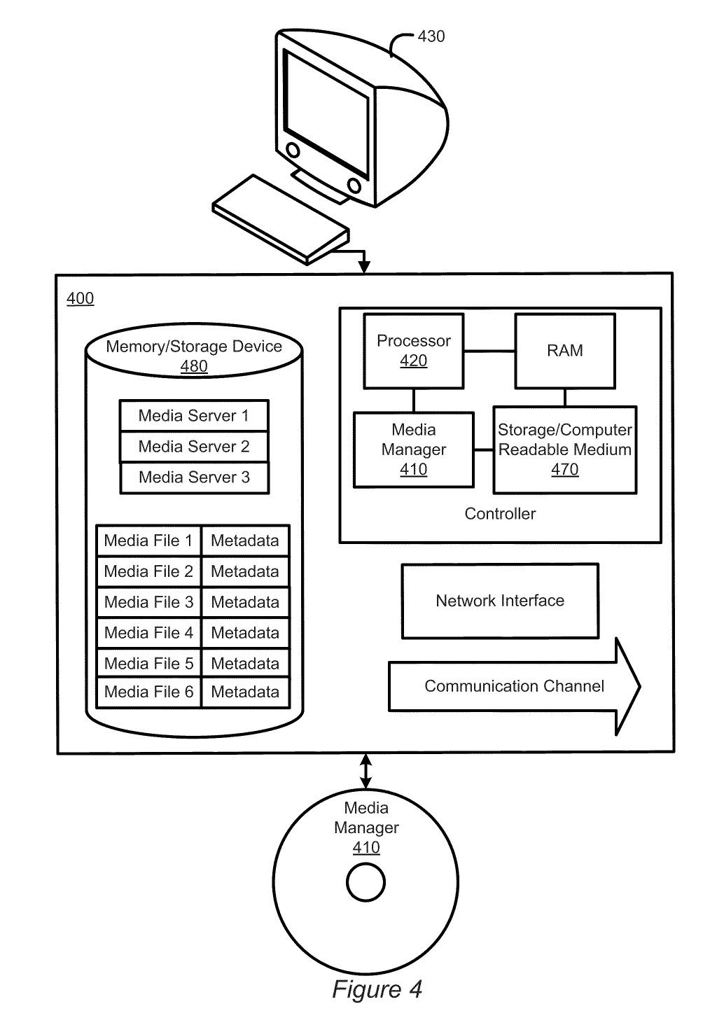

FIG. 4 illustrates a machine 400 with an embedded media manager 410 and a media manager 410 stored on a removable medium being accessed by the machine 400 according to an embodiment of the invention. For the purposes of this description, a removable medium is any tangible apparatus that contains, stores, communicates, or transports the application for use by or in connection with the machine 400. As noted above, in one embodiment, the media manager 410 is firmware that is embedded into one or more components of the machine 400 as ROM. In other embodiments, the media manager 410 is a software application which is stored and accessed from a hard drive, a compact disc, a flash disk, a network drive or any other form of computer readable medium that is coupled to the machine 400.

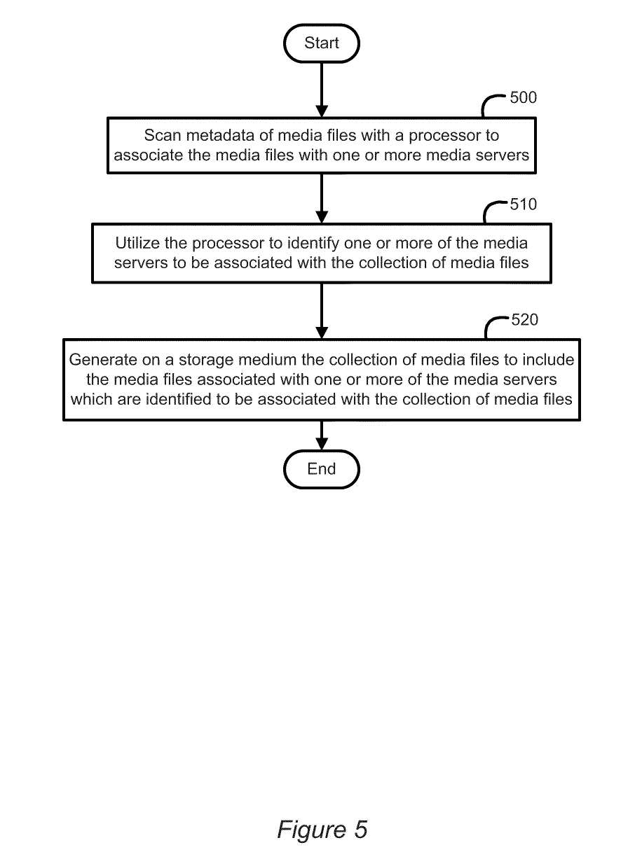

FIG. 5 is a flow chart illustrating a method for generating a collection of media files according to an embodiment of the invention. As noted above, the collection of media files includes media files associated with the media servers that have been identified to be associated with the collection of media files. The method of FIG. 5 uses a media manager on a machine, one or more media files stored on a memory/storage device, metadata associated with the media files, one or more media servers, a network interface, and one or more devices coupled to the machine. In other embodiments, the method of FIG. 5 uses additional components and/or devices in addition to and/or in lieu of those noted above and illustrated in FIGS. 1, 2, 3, and 4.

As noted above, the media manager will initially scan the memory/storage device for one or more media files. Additionally, as noted above, the media files are stored on a memory/storage device which is either directly coupled to the machine or remotely coupled to the machine through a network interface device of the machine. Once, the media manger has found one or more media files stored on the memory/storage device, the media manager will proceed to scan metadata of the media files with a processor to associate the media files with one or more media servers 500.

As noted above, the metadata of the media files specify users and/or media servers that are associated with the corresponding media files. In one embodiment, the metadata of the media files can specify that the corresponding media file is associated with a user. In other embodiments, the metadata of the media files can specify that the corresponding media file is associated with more than one user. Additionally, the users can be registered and recognized by the machine. Further, if the users are not already registered with the machine, the BIOS manager can proceed to register the users with the machine. In one embodiment, each of the users will have a corresponding media server. In other embodiments, one or more of the media servers include media files of a particular genre.

The media servers include one or more media files that the media manger has identified to be associated with the corresponding media server. Once all of the media files have been associated with one or more of the media servers, the media manager will proceed to configure the media servers to utilize a network interface on the machine to broadcast availability and information corresponding to a corresponding media server. In other embodiments, the media manager will instruct the network interface to broadcast the media signals for each of the media servers on the machine. One or more devices can detect the media signals and proceed to access the machine and request to view a collection of media files.

In another embodiment, the media servers do not broadcast media signals and the media manager configures the media servers to provide information corresponding to the media server when one or more devices query the corresponding media server. In other embodiments, the media manager does not broadcast the media signals and can supply a list of the media servers on the machine when one or more devices access the machine and query the machine for the list of media servers.

Once a device has requested to view the collection of media files, the processor configures the media manager to identify one or more of the media servers to be associated with the collection of media files 510. As noted above, a device can request that one or more of the media servers be associated with the collection of media files. Once the media manager has identified which of the media servers a corresponding device has specified to be associated with the collection of media files, the media manager will proceed to generate the collection of media files 520. As noted above, the processor will additionally configure the media manager to store the collection of media files on a storage medium. Additionally, as noted above, the collection of media files includes the media files which are associated with one or more of the media servers identified by the corresponding device to be associated with the collection of media files.

Further, as noted above, the media manager can then provide the collection of media files for the device to view. In one embodiment, the media manager can provide the collection of media files for view as a file listing all of the media files included in the collection of media files. The file can be shared with the corresponding device for display on the device. In another embodiment, the media manager can open a connection with the corresponding device and feed all of the media files included in the collection of media files for remote display on the corresponding device.

The method is then complete or the media manager can scan for one or more additional devices accessing the machine and requesting to view the collection of media files or an additional collection of media files utilizing the method disclosed above. In other embodiments, the method of FIG. 5 includes additional steps in addition to and/or in lieu of those depicted in FIG. 5.

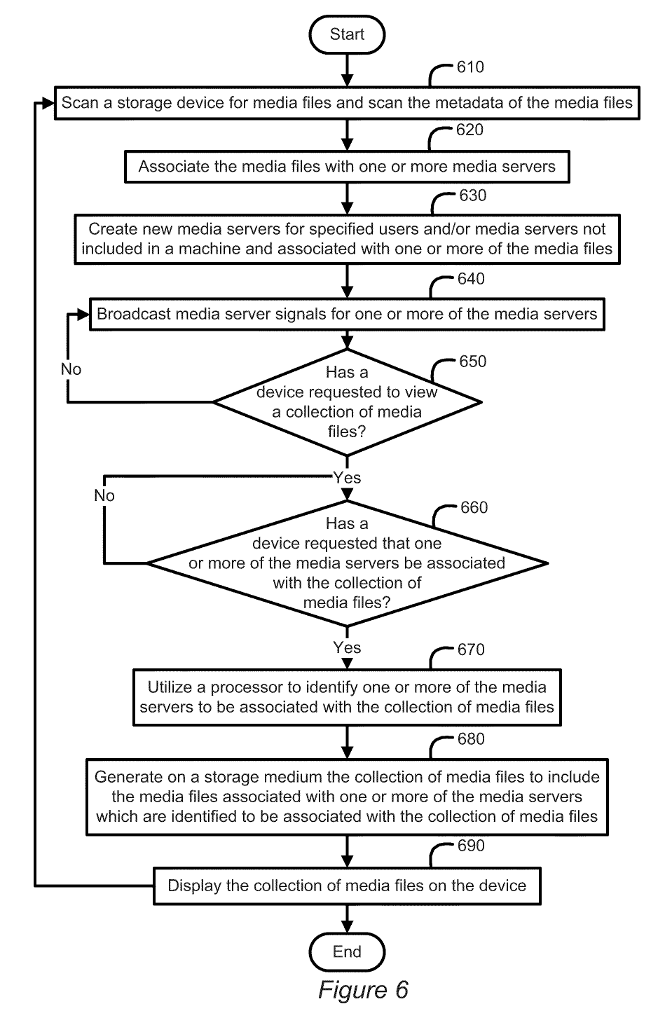

FIG. 6 is a flow chart illustrating a method for generating a collection of media files according to another embodiment of the invention. As noted above, the collection of media files includes media files associated with the media servers that have been identified to be associated with the collection of media files. Similar to the method of FIG. 5, the method of FIG. 6 uses a media manager on a machine, one or more media files stored on a memory/storage device, metadata associated with the media files, one or more media servers, a network interface, and one or more devices coupled to the machine. In other embodiments, the method of FIG. 6 uses additional components and/or devices in addition to and/or in lieu of those noted above and illustrated in FIGS. 1, 2, 3, and 4.

As noted above, in one embodiment, the media manager will initially scan a storage device for media files and proceed to scan the metadata of the media files found on the storage device 610. In one embodiment, as noted above, the media manager can also periodically scan the storage device for any additional media files which have been added to the storage device. Once the media manager has scanned the metadata of all of the media files found on the storage device, the media manager will proceed to associate the media files with one or more media servers 620.

In associating the media files, the media manager will scan the metadata of media files to determine whether the metadata specify any users or media servers the corresponding media file is to be associated with. As noted above, in one embodiment, each of the media servers correspond to one or more users registered on the machine. In other embodiments, one or more of the media servers include media files of a particular genre.

Additionally, if the metadata specify a media server or a user which already exists on the machine, the media manager will proceed to update the media servers and/or the media server corresponding to the user to include the corresponding media files. In another embodiment, if the metadata of any of the media files specify a media server that does not already exist on the machine, the media manager will proceed to create a new media server for the specified media server and proceed to include the corresponding media file in the specified media server. In other embodiments, if the metadata specify a user which does not already exist on the machine, the media manager will proceed to register the user with the machine, create a new media server for the specified media server, and include the corresponding media file in the new media server 630.

Once all of the media files have been associated with one or more of the media servers, the media manager will proceed to configure a network interface to broadcast media server signals for one or more of the media servers 640. In other embodiments, the media manager will not broadcast media server signals and scan for one or more devices accessing the device and querying the machine for a list of media servers available on the machine.

The media manager will then determine whether a device has requested to view a collection of media files 650. As noted above, the device can request to view the collection of media files by accessing the machine and sending a request to view the collection. If no device has requested to view the collection of media files, the media manager will continue to broadcast media server signals for one or more of the media servers 640. If the device has requested to view the collection of media files, the media manager will additionally determine whether the device has requested that one or more of the media servers be associated with the collection of media files 660.

As noted above, the device can specify one or more of the media servers broadcasted by the machine or included in the list be associated with the collection of media files. If the device has not specified one or more of the media servers to be associated with the collection of media files, the media manager will continue to poll the device to determine whether the device has requested that one or more of the media servers be associated with the collection of media files 660. In other embodiments, if the device has not specified one or more of the media servers to be associated with the collection of media files, the manager will proceed to associate all of the media servers on the machine with the collection. As a result, all of the media files on the machine will be included in the collection of media files.

If the device has requested one or more of the media servers to be associated with the collection of media files, the media manager will proceed to scan the media servers on the machine to identify one or more of the media servers to be associated with the collection of media files 670. The media manager will then create the collection of media files 680. As noted above, the collection of media files includes the media files of the media servers which have been identified to be associated with the collection of media files.

The media manager will then generate the collection of media files for the device to view 690. As noted above, the media manager is additionally configured by the processor to store the collection of media files on the storage device. Additionally, as noted above, in one embodiment, the media manager can create a file of the collection of media files to send to the device. In another embodiment, the media manager can establish a connection with the device and proceed to remotely share the media files included in the collection of media files with the device.

The method is then complete or the media manager can continue to periodically scan a storage device for media files and scan the metadata of the media files 610. As noted above, if the media manager finds any additional media files or if the metadata of any of the media files specify any changes in user associations of the media files, the media manager will proceed to update one or more of the user media servers in response to the changes in the user associations of the media files utilizing the method disclosed above 620.

Additionally, the media manager can create additional collections of media files for display for any additional devices accessing the machine and requesting to view the collection of media files or the additional collections of media files following the method disclosed above. In other embodiments, the method of FIG. 6 includes additional steps in addition to and/or in lieu of those depicted in FIG. 6.

By scanning metadata of media files on a storage device, a media manager on a machine can associate each corresponding media file with one or more media servers and/or one or more users. As a result, the machine can include and support multiple different media servers for all of the users registered on the machine. Additionally, by generating a customized collection of media files upon request by a device, flexibility and convenience for the device can be gained in viewing the media files of the media servers identified to be associated with the collection of media files.

What is claimed is:

1. A method for generating a collection of media files comprising:
scanning metadata of media files with a processor to associate the media files with one or more media servers;
utilizing the processor to identify one or more of the media servers to be associated with the collection of media files; and
generating on a storage medium the collection of media files to include the media files associated with one or more of the media servers which are identified to be associated with the collection of media files.

2. The method for generating a collection of media files of claim 1 wherein the media files and one or more of the media servers are stored on the storage medium.

3. The method for generating a collection of media files of claim 2 further comprising creating an additional media server when the processor determines that the additional media server is not stored on the storage medium and is associated with one or more of the media files.

4. The method for generating a collection of media files of claim 1 wherein each of the media servers correspond to a user registered on a machine where the collection of media files is created.

5. The method for generating a collection of media files of claim 4 further comprising registering an additional user on a machine coupled to the storage medium when the additional user is not registered on the machine and the additional user is determined by the processor to be associated with one or more of the media files.

6. The method for generating a collection of media files of claim 1 further comprising broadcasting media server signals of one or more of the media servers available to be included in the collection of media files.

7. The method for generating a collection of media files of claim 1 further comprising scanning for a device querying for a list of the media servers available on the machine.

8. The method for generating a collection of media files of claim 7 further comprising scanning the device for a request to associate one or more of the media servers in the collection of media files and displaying the collection of media files.

9. A machine comprising:
a processor configured to associate one or more media servers with a collection of media files;
a storage device including media files which are associated with one or more of the media servers in response to metadata of the media files; and
a media manager executable from computer readable memory by the processor and configured to generate the collection of media files to include the media files associated with one or more of the media servers identified to be associated with the collection of media files.

10. The machine of claim 9 further comprising a database configured to list the media servers and the media files associated with each media server.

11. The machine of claim 9 further comprising a networking interface for the machine to scan for and couple to one or more devices accessing the collection of media files.

12. The machine of claim 11 wherein the networking interface is configured by the processor to broadcast one or more media server signals.

13. The machine of claim 9 wherein the metadata specify an association between a corresponding media file and one or more of the media servers.

14. The machine of claim 9 wherein the metadata specify an association between a corresponding media file and one or more users.

15. The machine of claim 9 wherein the collection of media files includes the media files associated with all of the media servers.

16. The machine of claim 9 wherein the collection of media files includes the media files associated with one of the media servers.

17. A computer-readable program in a computer-readable medium comprising:
a media manager configured by a processor to associate media files with one or more media servers by scanning the metadata of the media files to identify associations of the media files;
additionally wherein the media manager is configured by the processor to identify one or more of the media servers to be associated with a collection of media files; and
further wherein the media manager is configured to generate the collection of media files on a storage medium to include the media files associated with one or more of the user media servers identified to be associated with the collection of media files.

18. The computer-readable program in a computer-readable medium of claim 17 wherein the media manager is additionally configured to periodically scan the metadata of the media files to detect changes in the user associations of the media files and update one or more of the user media servers in response to the changes in the user associations of the media files.

19. The computer-readable program in a computer-readable medium of claim 17 wherein the media manager is additionally configured to periodically scan the storage device for additional media files and the metadata of the additional media files to associate the additional media files with one or more of the media servers.

20. The computer-readable program in a computer-readable medium of claim 17 wherein the media manager is further configured to generate one or more additional collection of media files which list the media files associated with one or more of the media servers included in one or more of the additional collection of media files.
